(19) United States
(12) Patent Application Publication
(10) Pub. No.: US 2002/0128790 A1
(43) Pub. Date: Sep. 12, 2002

(54) System and method of automated part evaluation including inspection, disposition recommendation and refurbishment process determination

(76) Inventor: Donald Woodmansee, Simpsonville, SC (US)

Correspondence Address: BANNER & WITCOFF, LTD., ATTORNEYS FOR GENERAL ELECTRIC, 1001 G. STREET, N.W., ELEVENTH FLOOR, WASHINGTON, DC, 20001-4597, US

(21) Appl. No.: 09/801,858

(22) Filed: Mar. 9, 2001

(51) Int. Cl. G06F 19/00; G01N 37/00

(52) U.S. Cl. 702/81

(57) ABSTRACT

A system and method for automatically evaluating the dimensions and conditions of parts. The system and method involve inspecting a part for changes in its condition (usually during service), making a recommendation as to the disposition of the part for repair, and, if the part is repairable, determining a process to refurbish the part. The system and method utilize CMMs to not only take dimensional- and surface-related measurements of the part, but also to precisely take digital images of all part surfaces. These images are analyzed by computer software, and a computer-generated report outlining the condition of the part is then produced from the measurements. The report contains a disposition recommendation, and a recommended set of repair processes to successfully refurbish the part so that it can be returned for further service.

### FIELD OF THE INVENTION

The present invention relates to a system and method for evaluating parts to determine their status or disposition, and, if a part is salvageable, to subsequently recommend a process to refurbish the part. More particularly, the present invention relates to an automated method for inspecting parts prior to refurbishment and re-installation. The method uses automated coordinate measuring machines and imagers, image analysis software, and rules-based, logical disposition software.

### BACKGROUND OF THE INVENTION

The use of engines, generators and other heavy equipment is ubiquitous throughout the world. During normal operation of such equipment regular, planned maintenance is required to insure that the equipment operates reliably at relatively high levels of performance. In addition, maintenance of such equipment is further needed to insure that events that might result in complete failure of the equipment might be avoided. Such failure of the equipment may result in temporary downtime for the equipment, i.e. a forced outage, or its total destruction.

The revenue-generating value of keeping large engines, generators, and heavy equipment in service is measured in terms of equipment availability; i.e., the fraction of total chronological time the equipment is available to provide service, whether called upon or not. Availability for large equipment like gas turbines is maximized by having sets of spares available during a maintenance outage so that the major critical parts can be simply replaced with refurbished or new parts before the engine is then quickly reassembled and put back online quickly for continued service. For the case of a modern gas turbine engine, for example, the major critical parts in the hot section include combustion parts, turbine nozzles, and turbine buckets. Because the reliability of these parts is critical to engine availability, (i.e., minimized forced outages) they are exchanged on regular schedules with refurbished or new parts during engine outages. The parts are then sent to shops where they are inspected and then repaired for subsequent installation at a future engine outage. Because these parts are individually complex and expensive, and because they may see many differing types of engine operations in service and be repaired differently after each service, the parts are serialized; i.e., they are marked individually with a serial number at new make. This serialization enables the parts to be tracked during their lifetimes of alternating service and repair intervals. In what follows, the discussion will focus on these expensive serialized gas turbine parts, but this does not limit the applicability of the novel concepts here to apply to other systems and to parts, which are not serialized.

Currently, the inspection of parts removed from heavy equipment, such as generators and engines, usually after long periods of operation, requires a great deal of manpower. Each part is first removed, and then inspected to determine the disposition of that part. Disposition requires a determination be made concerning whether a part can be refurbished to restore it to a condition where the part can operate for another service interval.

Due to the high temperatures, the corrosive atmosphere and the forces placed on gas turbine parts, it is common for parts such as turbine buckets and nozzles to become damaged during use due to normal processes of oxidation, wear, and fatigue. Further, the parts may be damaged by the impact of foreign particles. As a result, the serviceable lifespan of the parts may be significantly reduced. Due to the manufacturing costs for such parts, numerous repair methods have been developed to refurbish the parts. When minimum dimensions or characteristics cannot be met the part is deemed incapable of being refurbished and is removed from service. Commonly, a part will have to be discarded after the part has been refurbished numerous times. because of irreversible damage accumulate during service, refurbishment processing, or both. The part may no longer have the minimum dimensional characteristics to be capable of achieving the purpose for which it is intended.

Presently, disposition determinations are made based upon visual inspections of the parts along with a few manual measurements. For some parts more detailed measurements are also made with computer controlled coordinate measuring machines. Visual inspections primarily provide a limited amount of information concerning the condition of the parts so as to make accurate disposition and repair work scope determinations. Part reliability would be enhanced by obtaining more detailed condition information, and in particular information relating the aging or wear out of parts to the amount of service the parts have undergone. Such more detailed records of part defect descriptions may be used to predict the reliability of parts relative to the onset and growth of defects.

The inventor has separately disclosed on the structure of a digital database of part conditions. That database accepts only digital data and is so structured that the data entered can be queryed in a logical, structured manner. While the condition description can include attached files of images, such as photos, marked-up schematics, text files, etc., the searchability of the database is assured by allowing data entry as continuous digital values; i.e., the observations are all numbers whose values have quantitative meaning. Questions with binary responses, such as are there cracks, “Yes/No”, are disallowed; the inspector is instead asked to report a count of the cracks.

The above described digital database structure would not change when the invention described herein is employed. The novel feature here is that the observations would be made by computer inspection instead of being made solely by a person. The benefit of this is clearly a faster, more objective inspection whose results could be stored and queryed along with archive data that was taken by inspection personnel. The advantage of this is that the inspection data could be queryed by the database computer engine regardless whether it was entered manually or by the computer image analysis program described below.

Coordinate measuring machines (CMMs) are commonly used to measure specific dimensions of parts with high accuracy. The CMMs may be used to more accurately quantify dimensional defects so that work plans to correct the defects can be more accurately specified. However, CMMs have not been incorporated into an automated system for part inspection.

CMMs employ a computer controlled probe that either makes contact with, or locates a part surface optically in order to determine the dimensions of the part. Computer aided design (CAD) use geometric modeling to simulate parts, and computer aided modeling (CAM) uses the geometric model to represent the formation of the part.

Furthermore, both charge-coupled device (CCD) cameras to capture digital images, and image analysis to identify features present in a software library are known technologies. However, these technologies have not been employed in an automated parts system to provide more efficient, accurate, more complete and faster inspection of the parts.

### BRIEF SUMMARY OF THE INVENTION

The foregoing and other deficiencies of the conventional techniques are addressed by the system and method of automated part evaluation including inspection, disposition recommendation and refurbishment process determination according to the present invention.

The present invention relates to a system and method of automatically inspecting parts. The system and method involve inspecting a part, recording digitally the condition of the part relative to new make, issuing a recommendation as to the disposition of the part and, if repairable, recommending processes to refurbish the part. The system and method utilize CMMs to take measurements of a part. A computer-generated report outlining the condition of the part is then produced from the measurements. The report contains digital description of part condition, a disposition recommendation, and a recommended set of repair processes to successfully refurbish the part so that it can be returned for further service.

### BRIEF DESCRIPTION OF THE DRAWINGS

The structure, operation and advantages of a presently preferred embodiment of this invention will become apparent upon consideration of the following description, taken in conjunction with the accompanying drawings in which:

FIG. 1 is a perspective view of a coordinate measuring machine (CMM) utilized in accordance with an exemplary embodiment of the present invention;

FIG. 2 is a block diagram of the system for evaluating parts to determine their status or disposition according to an exemplary embodiment of the present invention; and

FIG. 3 is a flow chart illustrating the method for evaluating parts to determine their status or disposition according to an exemplary embodiment of the present invention.

### DETAILED DESCRIPTION OF THE INVENTION

The system and method of the present invention have two components, an inspection component and an evaluation or analysis component. During inspection of a part, data concerning the condition of the part is developed. The evaluation component uses the data obtained by the inspection component to determine the disposition of the part, and if the part is determined to be refurbishable for another service interval, the steps required to achieve the refurbishment are set forth.

With regard to gas turbines, the present system and method can be used for a number of critical parts. In particular, with regard to combustion, the inspection of the fuel nozzle tips, which direct fuel/air mixtures to flame, could benefit from the system and method according to the present invention. Similarly, end covers that provide containment gas mixture plenums for the fuel nozzle tips could be inspected and analyzed according tot the present invention. Liner caps that fit inside the end covers and provide perfusion air to keep flame away from the fuel nozzle tips, liners, which are cylindrical can structures for containing flame, and transition pieces, namely ducts that provide geometric transition between round liners and sectional power nozzles, all would benefit from inspection and analysis according to the present invention.

Similarly, with regard to the hot gas path, the power nozzle, which is a stator part that accelerates, and turns hot gas flow azimuthally into the path of the buckets, and the buckets, which are rotor parts that react to the gas flow from the nozzle and provide torque to the turbine rotor, could be inspected and analyzed according to the present invention.

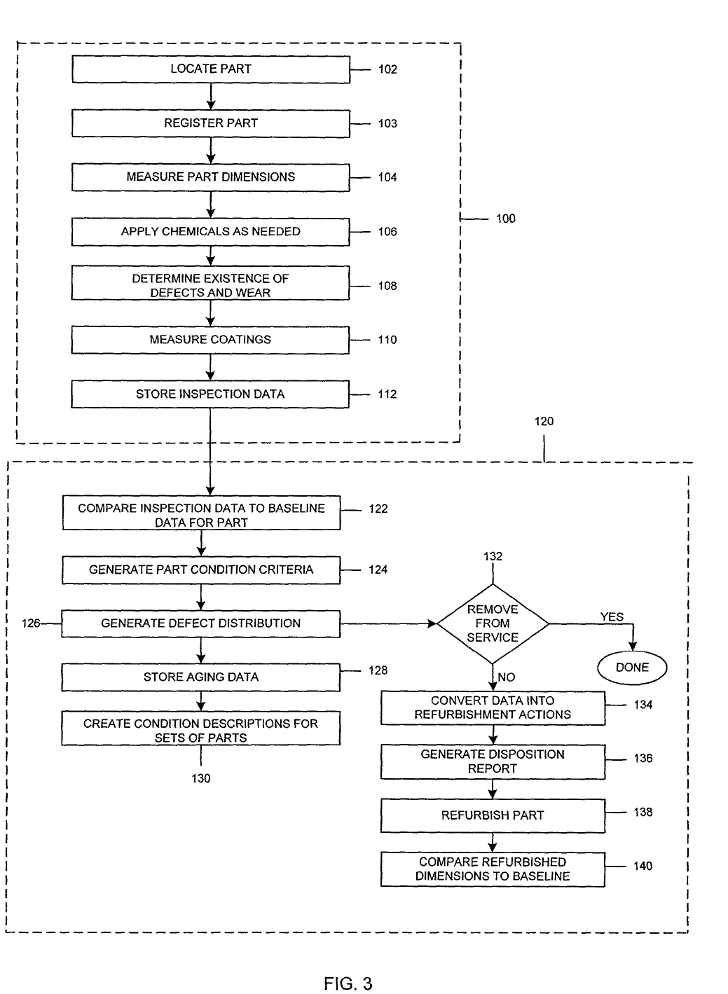

In the inspection stage 100, shown in FIG. 3, the part 10 is analyzed to determine the condition of the part 10 in two stages. First, the CMM measures various dimensions of the part 10 in step 104 using standard means to locate part surfaces using robotic measuring arm(s) and contact or optical head tools. This information is stored as part geometry files using processes in common use today. Second, the CMM robotic arm picks up a CCD camera 20 from its tool magazine and takes images of all accessible part surfaces under computer control, either as streaming video or as multiple, overlapping images. The video is then stored in a computer for analysis of the part images using automated computer image analysis software to identify part conditions relative to a library of surface conditions. Note that the position of the CCD camera 20 and its orientation relative to the part surfaces are precisely known by the CMM software so that subsequent image analysis can provide both the quantitative lengths and orientations of any defect with reference to the part geometry.

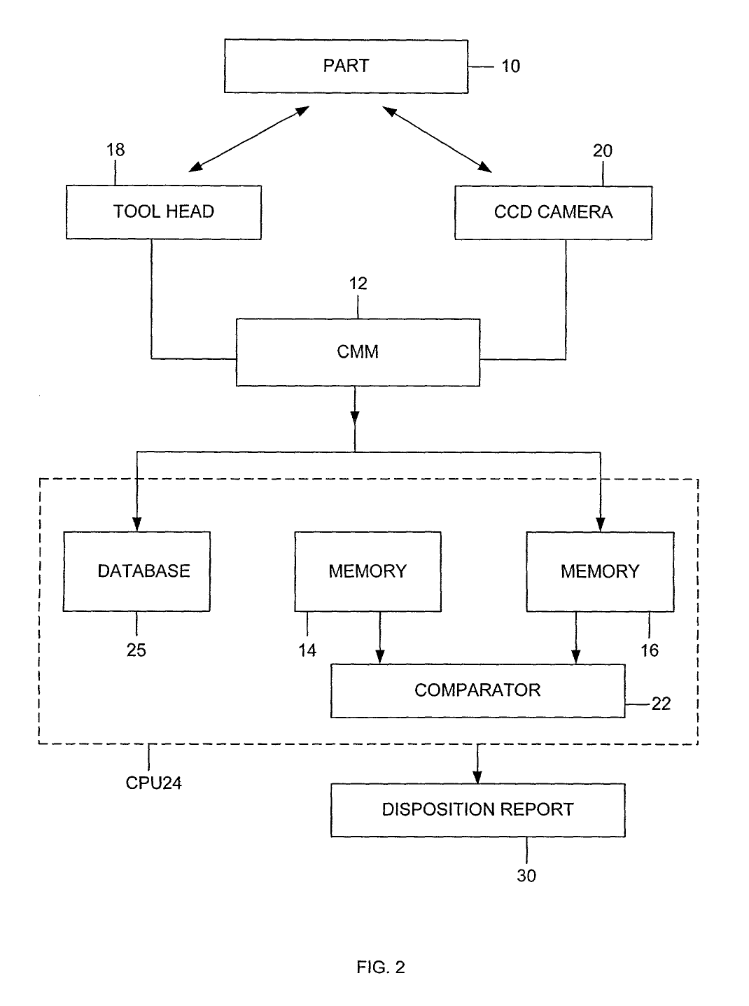

After the dimensional and the image digital data is collected in the inspection stage 100, it is stored in memory 16 of a central processing unit (CPU) 24 in step 112, and the collected data is compared by comparator 22 in step 122, to data stored in memory 14, shown in FIG. 2, in order to generate part condition criteria, in step 124, for use in disposing parts 10 for removal from service in step 132 or for refurbishment as set forth in a disposition report 30 in step 136. The memory 14, memory 16, comparator 22 and database 25 may all be maintained in the central processing unit 24.

The data stored in the memory 14 may include data relating to the dimensions of the part 10 in a new unused, or post-manufacturing, state as well as data relating to the minimum conditions below which the part 10 cannot be refurbished and therefore must be taken out of service. Such data may include the minimum acceptable dimensions for the part 10, the size and location of cracks, and/or the thickness and location of coatings on the part 10.

A part 10 is first measured with CMMs 12 after the initial manufacture of the part 10 and before the part 10 is ever put into service, and the dimensions are compared to geometric design dimensions to determine if the part 10 is suitable for use in service. After an initial service period, the part 10 is measured in step 104 to obtain dimensions to determine the aging of the part 10 relative to the initial part geometry including any coatings on the part 10, as set forth in steps 122-128. Next the part 10 is measured after it is cleaned and stripped so that the post-manufacturing dimensions may be compared to the dimensions of the part 10 after the initial service period. The differences between both of the foregoing measurements to the initial postmanufacture dimensions are then used to describe the aging of the part 10 during its first service period.

After refurbishment in step 138, the dimensions of the refurbished part 10 are compared once again to the original post-manufacture dimensions in step 140. Furthermore, the post-refurbishment dimensions may be used to establish a baseline for refurbishment of that type of part 10. Upon completion of a second service period, the foregoing steps are repeated, except that the baseline is now the post-first refurbishment geometry.

The design geometry files specify the desired dimensions of the surfaces for each part 10, as it exists at the end of the manufacturing process. These dimensions are tested using CMMs 12. In addition to the design geometry files, meshed finite element files are maintained in the part database stored in memory 14. These meshed finite element files are converted from the design geometry files, and contain structures and flow spaces that are mapped as networks of cells. Engineering analysis of stress and heat transfer is performed on the cells. Any changes in the structure are returned as revised geometry files.

The system and method of the present invention utilizes rules-based logic to convert the data developed in the inspection stage into recommended actions with regard to each inspected part 10.

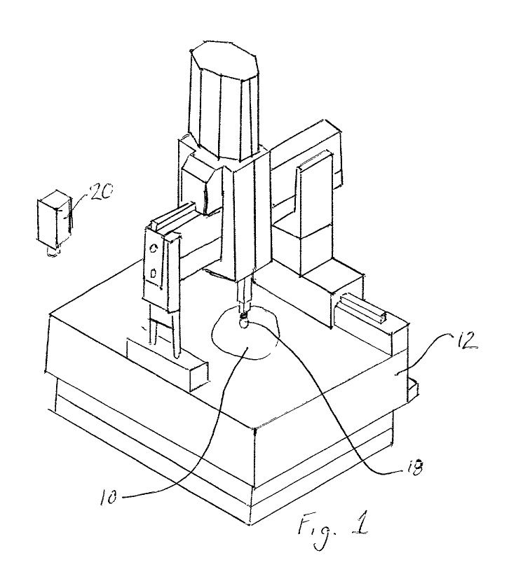

Referring to FIG. 1, using an inspection apparatus 11, the part 10 to be inspected is mounted into a CMM 12. The part 10 may have been preconditioned. Such preconditioning may include cleaning and/or application of a surface crack enhancer chemical.

The CMM 12 locates the part 10, in step 102, either by trial and error or the part 10 may be mounted in a fixture thereby accelerating the locating process. The CMM 12 then registers the part 10 with a CAD model of the part 10, in step 103. The registration may be accomplished by comparing the measurements of the part 10 with data stored in memory 14 until a match is made.

The CMM 12 measures all requested dimensions (step 104), and stores the measurements in a memory 16 (step 112). The measurements may be stored as deviations from a CAD model of either the post-manufacture part 10, or a model created from a prior CMM inspection of that same part 10. The measurements may include runouts for distortion and worn areas where original thickness dimensions are known from earlier inspections or from current measurements on the regions not in contact with other parts during operation.

The tool head 18 of CMM 12 then picks up a CCD camera 20 and activates the CCD camera 20 to capture images of part surfaces of interest. The images captured by the CCD camera 20 may be manipulated by image analysis software to produce continuous images of the regions being analyzed.

The image analysis software may also recognize and document the features and dimensions of cracks, edges of spalled coatings or layers, unusual colors, etc., to complement the dimensional measurements (step 108). The foregoing features may, for example, include the length, width, and orientation of cracks, dimensions of an area exhibiting discoloration, etc., recorded in a digital database describing part condition.

There are a number of conditions of the parts that can be tracked and stored in the digital database. The conditions can be used individually or in combination to assess the condition of a part. The menu of conditions can be applied to any parttype and to any identified part area on a part.

One group of conditions relates to coatings on the parts. The color of the coating may indicate overheating of the part, and may appear as discoloration of the metal coating from exposure. Loss of area of a coating is another condition that may be caused by erosion or oxidation and is confirmed by measuring a loss of height or width in an area along an axis of the part.

Another group of conditions concerns the substrate, and specifically relates to the color, oxidation/erosion depth, ands pitting of the metal substrate.

Crack-related conditions form a significant group. In particular, crack conditions include crack counts within an area, maximum crack length, the angle of the longest crack (to a reference part-type axis), the accumulated length of all the cracks, the minimum distance between ends of converging cracks, and the height and width of an area along an axis of the area experiencing craze cracking.

There are conditions relating to deformation, including bulging, depth, indentation or depression, and warping. Deposit conditions include deposit surface thickness, the average open diameter of cooling holes, and the percentage of all holes that are totally blocked.

Distance measurements may be taken relating to specific features including length, depth height and diameter measurements. These measurements can be compared with similar measurements for the same part performed at an earlier inspection.

For parts with an identified axis of revolution, an angle location may be noted to indicate a location on a part where a particular observation is made. Small-scale surface roughness may be measured.

Missing material from the part may be noted, including measurements of the height and width, and a count of the total number of locations of missing material for a part.

Conditions relating to the thermal barrier coating may be observed. In particular, the color, the erosion/corrosion, height and width of the maximum spalling, and the total spalling count may be observed. Finally, the height and width of the wear at a contact area may be noted.

Referring to FIG. 2., the data relating to critical engineering features, such as the distance from beginning to end of a crack, collar ovality, etc. may be computed and stored in an inspection database 25, along with the location of such engineering features on the part 10.

After conclusion of the inspection process, analysis software, incorporated in the analyzing apparatus 21, may then compute and present histograms of condition or defect distribution on the part 10. Any defects determined to exceed established limits may be used to denote the part 10 for removal from service as un-repairable, or to denote the part as requiring replacement of a section thereof (step 132). The information so gathered may then be utilized in a part inspection summary, complete with recommended disposition or a request for engineering evaluation for that part, if the conditional results are inconclusive to the rules-based disposition analysis program.

Upon completion of inspection of multiple similar parts, the condition analysis software can create condition descriptions for the complete set of parts 10 (step 130), using statistical representations and comparing them to values for other sets, or alternatively for an entire fleet of similar parts.

The images from the CCD camera 20 are kept in files in the memory to compare measurements for each individual part over the course of its serviceable lifetime. In addition, the CCD positions are stored for each individual flaw, thereby helping to identify new flaws or track old flaws. The system thus develops a database of inspection data that can help track flaw growth and defect distribution. The quantitative data from the image analysis and dimensioning measurements may be kept in a part life database (step 128). The data can be used to better predict part reliability, and the effectiveness of refurbishment techniques can be used can be tracked so that part life can be extended.

The final step is to utilize the set of defects and the corresponding intensity of those defects, for each part in order to choose appropriate refurbishment processes (step 134). The refurbishment processes may be specified in process application and capability guidelines, which are part of the specification rules-based program.

There are four categories or disposition conditions into which the analysis of a part 10 may be classified. The first category indicates that the part 10 may be reused as is, requiring no refurbishment. The second category specifies that the part 10 may be refurbished for subsequent reuse. The third category indicates that part 10 should be pulled aside for additional inspection, either automated or manual. The fourth category specifies that the part 10 should be scrapped, as it cannot be refurbished. For example, airfoils cannot be blended if the wall of the airfoil is too thin.

With regard to the inspection of the part 10, a variety of sensors may be employed. The sensors used in conjunction with the CMM 12 include, but are not limited to, touch sensors, CCD cameras 20 for imaging, eddy current sensors, ultrasonic sensors, flash heating and infrared sensors, and surface roughness sensors (either contact or optical).

The touch sensors measure part dimensions, as discussed previously. The CCD camera 20 is used for imaging to view cracks with fluorescent penetrant, to view missing material discovered from comparison with design geometry, and to view color changes. The eddy current sensors can be used to detect cracks. Ultrasonic sensors can detect inclusions submerged within the part, as well as wall thickness. The flash heating and infrared sensors may be employed to detect all thickness. The surface roughness sensor may be used to quantify surface micro-topology using a stylus, a focused micro-beam, or image clarity/focus over area.

Various chemicals may used to improve the results detected by the sensors (step 106) within the CMM environment. In particular, a fluorescent penetrant may be applied to the part 10 to visualize closed cracks, as is commonly done in manual inspections. Furthermore, water may be applied to act as a medium for ultrasonic detection using currently available water-jetting techniques.

Performing multiple operations on the inspected parts can increase the accuracy and degree of confidence, in the measurements and detected defects. For example, image color/brightness changes indicating potential TBC layer spalling, can be confirmed by localized CMM measurements. TBC layer thickness can be compared to measured surface roughness to determine erosion. The existence and degree of cracking can be confirmed by using eddy current sensors. Other combinations of techniques can be employed to confirm previous measurements, or to obtain additional data.

In the foregoing discussion, the CMM may also be utilized to automatically control fluid flows that assist in the part inspection. The use of a water jet to enable ultrasonic measurement was discussed. This is somewhat unusual to do in a CMM environment, but is possible. Both a modern, computer driven CMM and a modern 5-axis milling machine tool possess the same abilities to locate tools precisely in a geometric space. The difference is that the milling machine is designed to exert forces on the work-piece during material removal or spraying operations, while he CMM is designed to operate quickly with minimum workpiece forces. The use of the CMM to automatically dispense and apply liquids to the work-piece is a possible extension of the CMM function without compromising its ability to measure and record work-piece geometries quickly. With this capability, the CMM could not only conduct the mentioned ultrasonic measurement of surface flaws, but also paint the work-piece part with chemicals that assist in crack identification, such as fluorescent penetrants, and even conduct local etching operations. Both would be followed by the CCD image analysis to determine crack length and orientation (for penetrants) and even identify grain structure characteristics (for etchants). Other similar liquid inspection aids could be dispensed and the results viewed in similar fashion in such an enhanced-CMM environment.

The repair processes for refurbishing parts 10, after the new automated inspection, include, but are not limited to, cleaning, stripping, blending, cutting-back, welding, recoating, and re-spraying. Cleaning may be done by forcing air onto the part or by dusting or washing. Stripping may involve the removal of thermal barrier coat (TBC) layers, or the removal of metal corrosion coating. Blending is the grinding of surface cracks to remove the crack leaving a smooth surface. Cutting-back is the machining of a surface material until surface cracks are removed. Welding is used to repair cracks and to rebuild lost material. A corrosion barrier may be added by recoating. Typically the corrosion barrier is 2-20 mils. TBC layers, typically 10-50 mils thick, may be applied by re-spraying.

With regard to conventional inspections, the accuracy of the CMMs is correct to 0.1 mil absolute, whereas current manual inspection measurements are relative and often made to only 5 mil accuracy to time constraints. In addition, the CMMs can measure more points per unit time than a person, the CMM being up to 1000 times faster. As a result the inspection process is much faster than conventional manual inspection.

Furthermore, the present system and method is more efficient than conventional manual techniques. The present invention does not require that parts be mounted in a fixture. The CMM can locate the part, find reference points, consult the design geometry file for approximate dimensions, and perform final measurements much faster than a person. The entire process may take only two or three minutes per part. Further, the CMM can position and operate the CCD camera faster and more accurately than a person taking images, and no person is involved in the first iteration of part measurement. Finally, discovered and quantified defects or flaws can be fed into a rules-based refurbishment-planning document.

Having described embodiments of the system and method of automated part evaluation including inspection, disposition recommendation and refurbishment process determination according to the present invention, it is believed that other modifications, variations and changes will be suggested to those skilled in the art in view of the description set forth above. It is therefore to be understood that all such variations, modifications and changes are believed to fall within the scope of the invention as defined in the appended claims

What is claimed is:

1. A system for automatically evaluating a part comprising:
inspecting apparatus for collecting data concerning the part; and
analyzing apparatus for determining if the part can be returned to service and for producing a report on the condition and disposition of the part and a recommended set of repair processes to refurbish the part, based on said collected data.

2. A system for automatically evaluating a part as recited in claim 1, wherein said inspecting apparatus comprises:
a coordinate measuring machine to measure the dimensions of the part;
sensors to detect defects in and wear of the part; and
a memory for storing measurement data from said coordinate measuring machine and output from said sensors.

3. A system for automatically evaluating a part as recited in claim 2, wherein said coordinate measuring machine measures said dimensions by touching the part.

4. A system for automatically evaluating a part as recited in claim 2, wherein said coordinate measuring machine measures said dimensions with optical sensing of the part.

5. A system for automatically evaluating a part as recited in claim 2, wherein said sensors comprise:
a CCD camera;
a touch sensor;
eddy current sensors;
ultrasonic sensors;
flash heating sensors;
infrared sensors; and
surface roughness sensors.

6. A system for automatically evaluating a part as recited in claim 2, wherein said inspecting apparatus further comprises an apparatus for applying a substance to the part prior to inspection.

7. A system for automatically evaluating a part as recited in claim 6, wherein said substance is a fluorescent penetrant to enhance crack visualization.

8. A system for automatically evaluating a part as recited in claim 6, wherein said substance is water to enhance ultrasonic detection.

9. A system for automatically evaluating a part as recited in claim 1, wherein said analyzing apparatus comprises:
a memory for storing measurement post-manufacturing data for classes of parts, inspection data from a previous inspection of the part, and minimum acceptable conditions for the part;
a database of refurbishment processes;
a comparator to compare inspection data and data in said memory; and
a processor that generates refurbishment steps for said part when said comparator indicates that the part can be refurbished.

10. A system for automatically evaluating a part as recited in claim 9, wherein said processor utilizes rules-based logic to convert said inspection data into said refurbishment steps.

11. A system for automatically evaluating a part as recited in claim 9, wherein said minimum acceptable data comprises:
minimum dimensions for the part;
crack size and location data; and
surface roughness data.

12. A system for automatically evaluating a part comprising:
apparatus inspecting the part and collecting data concerning the part; and
apparatus for analyzing said data to determine if the part can be returned to service and producing a report on the condition and disposition of the part and a recommended set of repair processes to refurbish the part,
said inspecting apparatus comprising:
a coordinate measuring machine to measure the dimensions of the part;
sensors to detect defects in and wear of the part, said sensors comprising at least one of: a CCD camera, a touch sensor, eddy current sensors, ultrasonic sensors, flash heating sensors, infrared sensors, and surface roughness sensors;
a memory for storing measurement data from said coordinate measuring machine and output from said sensors; and
an apparatus for applying a substance to the part prior to inspection, wherein said substance is one of a fluorescent penetrant to enhance crack visualization, and water to enhance ultrasonic detection.

13. A system for automatically evaluating a part as recited in claim 1, wherein said analyzing apparatus comprises:
a memory for storing measurement post-manufacturing data for classes of parts, inspection data from a previous inspection of the part, and minimum acceptable conditions for the part;
a database of refurbishment processes;
a comparator to compare inspection data and data in said memory; and
a processor that generates refurbishment steps for said part when said comparator indicates that the part can be refurbished;
wherein said processor utilizes rules-based logic to convert said inspection data into said refurbishment steps, and wherein said minimum acceptable data comprises:
minimum dimensions for the part;
crack size and location data; and
surface roughness data.

14. A method for automatically evaluating a part comprising the steps of:
locating a part;
inspecting the part and collecting data concerning the part;
registering the part to determine the identity of the part;
storing said collected data;
analyzing said collected data to determine if the part can be returned to service;
producing a report on the condition and disposition of the part; and
recommending a set of repair steps to refurbish the part if said analyzing step determines that the part can be returned to service.

15. A method for automatically evaluating a part as recited in claim 14, wherein said locating step is performed by mounted the part in a fixture.

16. A method for automatically evaluating a part as recited in claim 14, wherein said inspecting step comprises the steps of
measuring dimensions of the part; and
detecting defects and wear in the part.

17. A method for automatically evaluating a part as recited in claim 14, wherein in said registering step comprises comparing the collected data to data for multiple parts to determine an identity of the part.

18. A method for automatically evaluating a part as recited in claim 16, wherein said detecting step comprises at least one of the following steps:
taking images of said part;
applying an eddy current;
applying ultrasonic radiation;
flash heating the part;
applying infrared radiation; and
measuring surface roughness.

19. A method for automatically evaluating a part as recited in claim 14, wherein said analyzing step comprises the further steps of:
comparing said collected data to baseline data to determine if the part meets minimum conditions for refurbishment; and
generating a defect distribution report.

20. A method for automatically evaluating a part as recited in claim 14, wherein said step of recommending a set of repair processes to refurbish the part comprises the steps of converting results from said analyzing step to produce a set of refurbishment actions.

21. A method for automatically evaluating a part as recited in claim 14, wherein said analyzing and recommending steps utilize rules-based logic to convert said collected data into said repair steps.

22. A method for automatically evaluating a part as recited in claim 14, further comprising he steps of storing aging data for the part, and creating condition descriptions for sets of the same type of part.

23. A method for automatically evaluating a part comprising the steps of:
locating a part;
inspecting the part and collecting data concerning the part by measuring dimensions of the part and detecting defects and wear in the part;
registering the part to determine the identity of the part by comparing the collected data to data for multiple parts to determine an identity of the part;
storing said collected data;
analyzing said collected data to determine if the part can be returned to service, said analyzing step comprises the further steps of comparing said collected data to baseline data to determine if the part meets minimum conditions for refurbishment and generating a defect distribution report;
producing a report on the condition and disposition of the part; and
recommending a set of repair steps to refurbish the part if said analyzing step determines that the part can be returned to service, wherein said step of recommending a set of repair processes to refurbish the part comprises the steps of converting results from said analyzing step to produce a set of refurbishment actions and generating a disposition report.

24. A method for automatically evaluating a part as recited in claim 16, wherein said detecting step comprises at least one of the following steps:
taking images of said part;
applying an eddy current;
applying ultrasonic radiation;
flash heating the part;
applying infrared radiation; and
measuring surface roughness.

25. A method for automatically evaluating a part as recited in claim 23, wherein said analyzing and recommending steps utilize rules-based logic to convert said collected data into said repair steps.
